(19) United States
(12) Patent Application Publication
(10) Pub. No.: US 2002/0049399 A1
(43) Pub. Date: Apr. 25, 2002

(54) Brush treatment appliance having a treatment brush having bristles which are inclined with respect to the bristle holder

(76) Inventor: Roland Stampf, Klagenfurt (AT)

Correspondence Address: Corporate Patent Consel, Philips Electronics North America Corporation, 580 White Plains Road, Tarrytown, NY, 10591, US

(21) Appl. No.: 09/976,227

(22) Filed: Oct. 12, 2001

(30) Foreign Application Priority Data
Oct. 17, 2000 (EP) 00890315.5

(51) Int. Cl. A61H 15/00

(52) U.S. Cl. 601/114; 601/112

(57) ABSTRACT

In a body treatment appliance (1) having a treatment brush (6) which is drivable with respect to a brush axis (13) and which has a bristle holder (12) having a substantially flat bounding surface (15) and serving to hold bristles (16), which are preferably arranged in tufts and whose free ends define an enveloping surface (18), no tuft whose bristles (16) extend up to the enveloping surface (18) are arranged in the area of the brush axis (13) and at least the tuft (17) arranged in the vicinity of the brush axis (13) is arranged so as to be inclined with respect to the bounding surface (15) and so as to diverge from the brush axis (13) in the direction from the bounding surface (15) towards the enveloping surface (18).

The invention relates to a body treatment appliance having a treatment brush which has a bristle holder having a substantially flat bounding surface and which has bristles whose free ends define en enveloping surface, the treatment brush having no bristles which extend up to the enveloping surface in the area of its brush axis. The invention further relates to a treatment brush.

Such a body treatment appliance is known from the patent document U.S. Pat. No. 4,203,431 A. In the known appliance all the bristles and tufts of bristles project from the bristle holder in a perpendicular direction. With the known appliance this leads to the situation that during a rotation of the treatment brush about its brush axis while the bristles are applied to a body area to be treated, for example a facial area, the tufts are subjected to a force which causes the tufts to be deformed in such a manner that at least the inner tufts are bent in directions towards the brush axis, which results in a denser concentration of bristles in the area of the brush axis, which during use of the known appliance gives a person using the appliance the unpleasant impression of a pointed bristle configuration acting as a drill, which is an unpleasant experience, particularly during the treatment of sensitive body areas such as facial areas.

It is an object of the invention to preclude the aforementioned problems and to realize an improved body treatment appliance and an improved treatment brush.

In order to achieve the aforementioned object characteristic features in accordance with the invention are provided in a body treatment appliance in accordance with the invention, in such a manner that a body treatment appliance in accordance with the invention can be characterized in the manner defined hereinafter, namely:

A body treatment appliance having a housing to be held in a hand and having a driving arrangement accommodated in the housing and having a treatment brush which is drivable with respect to a brush axis with the aid of the driving arrangement and which has a bristle holder having a substantially flat bounding surface and having bristles connected to and projecting from the bristle holder in the area of its bounding surface, of which bristles at least a large part of these bristles define an enveloping surface by means of the free ends of these bristles, in which the treatment brush does not have any bristles which extend up to the enveloping surface in the area of its brush axis and in which at least the bristles arranged in the vicinity of the brush axis are arranged so as to be inclined with respect to the bounding surface and so as to diverge from the brush axis in the direction from the bounding surface towards the enveloping surface.

In order to achieve the aforementioned object characteristic features in accordance with the invention are provided in a treatment brush in accordance with the invention, in such a manner that a treatment brush in accordance with the invention can be characterized in the manner defined hereinafter, namely:

A treatment brush which is drivable with respect to a brush and which has a bristle holder having a substantially flat bounding surface and having bristles connected to and projecting from the bristle holder in the area of its bounding surface, of which bristles at least a large part of these bristles define an enveloping surface by means of the free ends of these bristles, in which the treatment brush does not have any bristles which extend up to the enveloping surface in the area of its brush axis and in which at least the bristles arranged in the vicinity of the brush axis are arranged so as to be inclined with respect to the bounding surface and so as to diverge from the brush axis in the direction from the bounding surface towards the enveloping surface.

As a result of the provision of the measures in accordance with the invention it is achieved that at least near the bristles arranged in the vicinity of the brush axis of the treatment brush, which bristles are preferably arranged in tufts, always a radially outward reactive force is produced during operation of the body treatment appliance, which precludes an undesired denser concentration of bristles in the area near the brush axis and, consequently, an unpleasant drill effect produced by a denser bristle configuration.

In a body treatment appliance in accordance with the invention only the bristles arranged in the direct proximity of the brush axis may be inclined with respect to the flat bounding surface of the brush holder. However, it has proved to be particularly advantageous when all the bristles of the treatment brush are arranged so as to be inclined with respect to the flat bounding surface of the bristle holder and so as to diverge outwards. With such an embodiment a drill effect produced by a denser bristle configuration in the central area of the treatment brush is avoided with a particularly great certainty.

The above-mentioned as well as further aspects of the invention will become apparent from the embodiments described hereinafter by way of example and will be elucidated with reference to these examples.

The invention will now be described in more detail with reference to the drawings, which show three embodiments which are given by way of example but to which the invention is not limited.

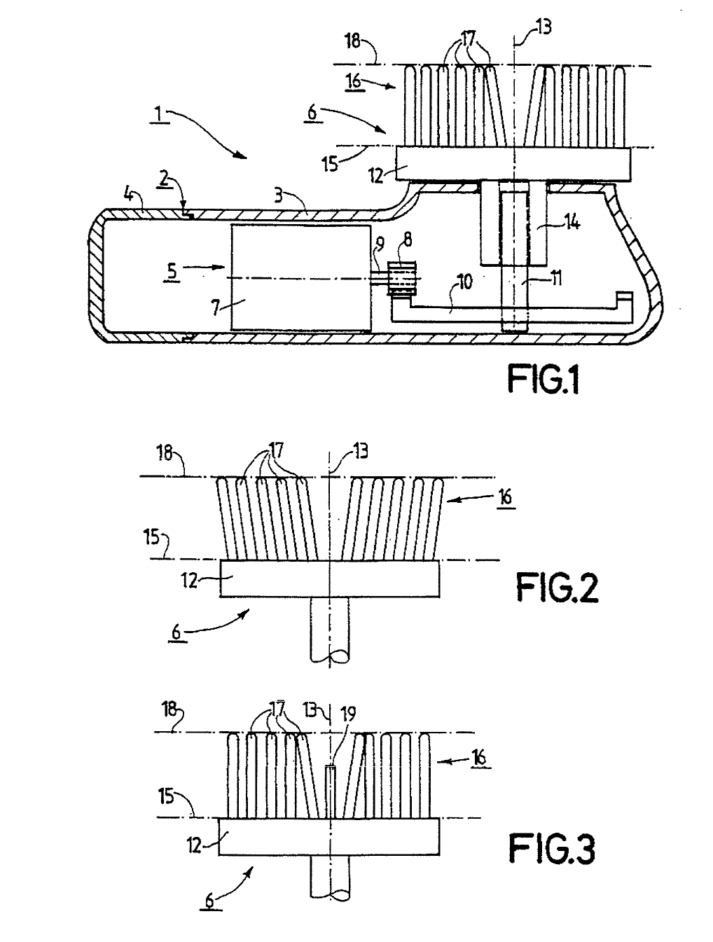

FIG. 1 is a diagrammatic side view which shows a body treatment appliance namely a facial treatment appliance in accordance with a first embodiment of the invention having a treatment brush in accordance with a first embodiment of the invention, the housing being shown in sectional view.

FIG. 2 shows a treatment brush in accordance with a second embodiment of the invention for a facial treatment appliance in accordance with a second embodiment of the invention.

FIG. 3 shows a treatment brush in accordance with a third embodiment of the invention for a facial treatment appliance in accordance with a third embodiment of the invention.

FIG. 1 shows a facial treatment appliance 1, hereinafter briefly referred to as the appliance 1. The appliance 1 has a housing 2 to be held in a hand and consisting of a main section 3 and a closing section 4. The housing 2 accommodates a driving arrangement 5. The driving arrangement 5 serves to drive a treatment brush 6. The driving arrangement 5 includes a motor 7, a pinion 8, which is mounted on a shaft 9 of the motor 7, and a crown wheel 10, which meshes with the pinion 8 and which is rotationally locked to a drive shaft 11, which is rotatably journaled in a manner not shown. The treatment brush 6 is drivable by means of the drive shaft 11.

The treatment brush 6 has a disc-shaped bristle holder 12, which is coaxial with a brush axis 13 of the treatment brush 6, which brush axis 13 is coaxial with the drive shaft 11. A drive sleeve 14 is integral with the bristle holder 12. The drive sleeve 14 projects towards the drive shaft 11. The drive sleeve 14 is coupled to the drive shaft 11 by coupling means, not shown. The coupling means may be formed by, for example, an interlocked coupling. In this way, it is achieved that the treatment brush 6 can be removed from the drive shaft 8, for example to clean the treatment brush 6 or to replace the treatment brush 6 with another treatment brush.

In the present case, the treatment brush 6 can be driven by means of the driving arrangement 5 so as to be rotatable with respect to the brush axis 13, i.e. always in the same direction of rotation. However, it is alternatively possible to choose a construction in which the treatment brush 6 performs a reciprocatory swinging movement or rotation with respect to the brush axis 13.

In the present case the bristle holder 12 has a flat bounding surface 15, which is shown as a dash-dot line. The treatment brush 6 has bristles 16 which are connected to the bristle holder 12 in the area of its flat bounding surface 15 and which project from the bristle holder 12, the bristles 16 being arranged to form a plurality of tufts 17, as is known per se since long from various types of brushes. The bristles 16 are not shown separately in the Figures but are always shown in the form of tufts 17 only. The free ends of the bristles 16 and the tufts 17 define an enveloping plane 18, which extends parallel to the flat bounding surface 15 of the bristle holder 12 and which is shown as a dash-dot line in FIG. 1. However, the enveloping plane may alternatively be a slightly convex enveloping surface.

In the case of the facial treatment appliance 1 the treatment brush 6 has no bristles in the area of its brush axis 13, i.e. it has no tuft whose bristles extend up to the enveloping plane 18. In the present case there is no tuft at all in the area of the brush axis 13; i.e. there are no bristles at all in this area. As regards the construction of the treatment brush 6 of the appliance 1 it is to be noted that advantageously the bristles 16, i.e. the tufts 17 arranged in the vicinity of the brush axis 13 are arranged so as to be inclined with respect to the flat bounding surface 15 of the bristle holder 12 and so as to diverge from the brush axis 13 in the direction from the bounding surface 15 towards the enveloping plane 18, i.e. pointing away from the brush axis 13. Here, the inclination of the bristles 16 and the tufts 17 with respect to the bounding surface 15 is the same for all the bristles 16 and tufts 17, but this is not necessarily so.

At this point, it is emphasized that the representation of the treatment brush 6 and of the tufts 17 has been chosen in such a manner that only the tufts 17 situated in a cross-sectional plane through the brush axis 13 are shown, in contradistinction to the tufts 17 situated behind this plane in the representation as in FIG. 1 though in reality they are present of course.

In a particularly advantageous manner all the bristles 16, i.e. all the tufts 17 of the treatment brush 6 shown in FIG. 2 are arranged so as to be inclined with respect to the bounding surface 15 and all the bristles 16, i.e. all the tufts 17, are arranged so as to diverge from the brush axis 13 in a direction from the bounding surface 15 of the bristle holder 12 towards the enveloping plane 18.

The treatment brush 6 shown in FIG. 3 is similar to the treatment brush 6 shown in FIG. 1 but, although the treatment brush 6 shown in FIG. 3 neither has any tufts whose bristles extend up to the enveloping plane 18, it differs in that in the area of its brush axis 13 it has a shorter tuft 19.

In all the embodiments described hereinafter it is advantageously achieved that no undesired denser concentration of bristles 16 occurs in the area near the brush axis 13, as a result of which an unpleasant effect on facial areas during use of the relevant facial treatment appliances 1 are avoided.

The construction in accordance with the invention can be used not only in facial treatment appliances but also in other body treatment appliances, such as breast massaging appliances and the like.

1. A body treatment appliance (1)
having a housing (2) to be held in a hand and
having a driving arrangement (5) accommodated in the housing (2) and
having a treatment brush (6) which is drivable with respect to a brush axis (13) with the aid of the driving arrangement (5) and which has a bristle holder (12) having a substantially flat bounding surface (15) and having bristles (16) connected to and projecting from the bristle holder (12) in the area of its bounding surface (15), of which bristles (16) at least a large part of these bristles (16) define an enveloping surface (18) by means of the free ends of these bristles (16),
in which the treatment brush (6) does not have any bristles which extend up to the enveloping surface (18) in the area of its brush axis (13) and in which at least the bristles (16) arranged in the vicinity of the brush axis (13) are arranged so as to be inclined with respect to the bounding surface (15) and so as to diverge from the brush axis (13) in the direction from the bounding surface (15) towards the enveloping surface (18).

2. A body treatment appliance (1) as claimed in claim 1,
in which all the bristles (16) of the treatment brush (6) are arranged so as to be inclined with respect to the bounding surface (15) and so as to diverge from the brush axis (13) in the direction from the bounding surface (15) towards the enveloping surface (18).

3. A treatment brush (6) which is drivable with respect to a brush axis (13) and which has a bristle holder (12) having a substantially flat bounding surface (15) and having bristles (16) connected to and projecting from the bristle holder (12) in the area of its bounding surface (15), of which bristles (16) at least a large part of these bristles (16) define an enveloping surface (18) by means of the free ends of these bristles (16),
in which the treatment brush (6) does not have any bristles which extend up to the enveloping surface (18) in the area of its brush axis (13) and in which at least the bristles (16) arranged in the vicinity of the brush axis (13) are arranged so as to be inclined with respect to the bounding surface (15) and so as to diverge from the brush axis (13) in the direction from the bounding surface (15) towards the enveloping surface (18).

4. A treatment brush (6) as claimed in claim 3,
in which all the bristles (16) of the treatment brush (6) are arranged so as to be inclined with respect to the bounding surface (15) and so as to diverge from the brush axis (13) in the direction from the bounding surface (15) towards the enveloping surface (18).
